(19) United States
(12) Patent Application Publication
(10) Pub. No.: US 2003/0001906 A1
(43) Pub. Date: Jan. 2, 2003

(54) Moving an object on a drag plane in a virtual three-dimensional space

(76) Inventors: John J. Light, Beaverton, OR (US); John D. Miller, Portland, OR (US); Michael D. Smith, Hillsboro, OR (US); Sunil Kasturi, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/896,072

(22) Filed: Jun. 28, 2001

(51) Int. Cl. G06F 3/00

(52) U.S. Cl. 345/849; 345/848

(57) ABSTRACT

A method of moving an object on a drag plane in a virtual three-dimensional (3D) space, includes selecting the object using a cursor, moving the cursor to a location, creating a reference plane, projecting movement of the cursor to the location to an interim point on the reference plane, projecting the interim point onto the drag plane, and displaying the object at the location on the drag plane.

### TECHNICAL FIELD

This invention relates to moving an object on a drag plane in a virtual three-dimensional (3D) space.

### BACKGROUND

In a two-dimensional (2D) space, an object is moved by selecting the object using an input/output (I/O) interface such as a mouse. A mouse button is depressed with the cursor on the object and the object is “grabbed.” By moving the mouse, the object is “dragged” to a desired location in 2D space while the cursor moves with the object. After releasing the mouse button, the object is positioned at the desired location.

### DESCRIPTION OF THE DRAWINGS

FIG. 1 is a screenshot of a three-dimensional (3D) scene.

FIG. 2 is a side view of a virtual 3D scene.

FIG. 3 is a side view of a virtual 3D scene depicting a drag angle.

FIG. 4 is a flowchart of a process for moving an object.

FIG. 5 is a side view of a virtual 3D scene depicting a drag plane and a reference plane.

FIG. 6 is a side view of a virtual 3D scene showing interim movement of an object on a reference plane.

FIG. 7 is a side view of a virtual 3D scene showing a projection of a cursor onto a drag plane.

FIG. 8 is a block diagram of a computer system on which the process of FIG. 4 may be implemented.

### DESCRIPTION

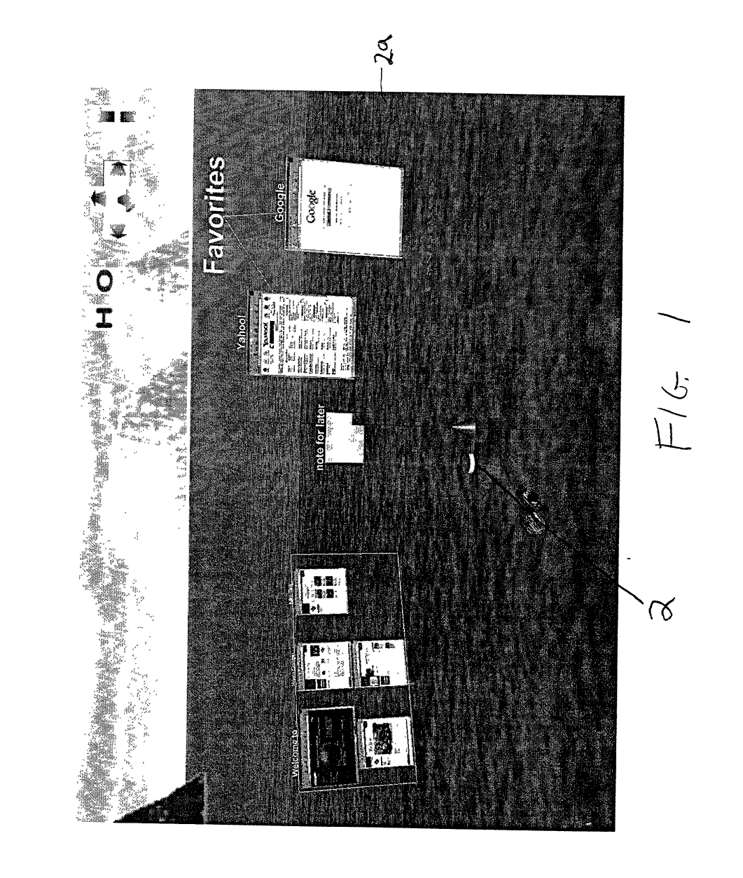

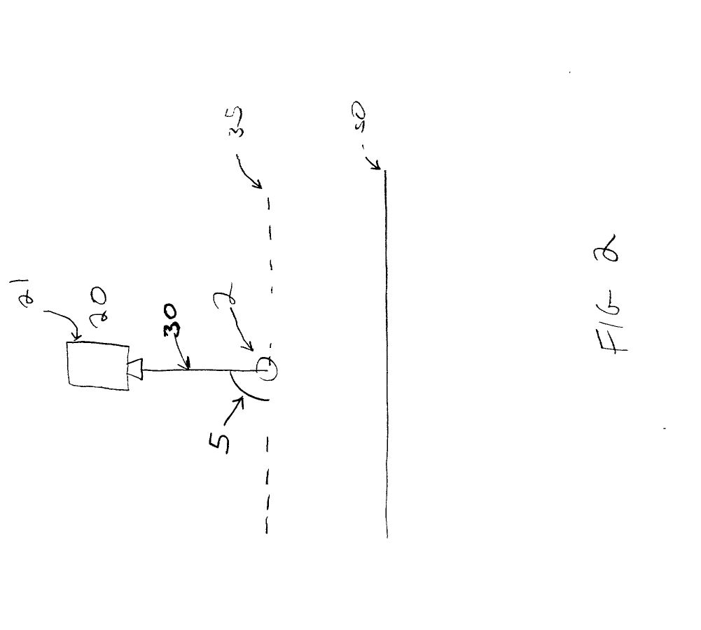

FIG. 1 is a screenshot of a 3D space. A 3D object 2 can be moved anywhere in the 3D space along drag plane 2a. FIG. 2 shows a graphical representation of the virtual 3D space with object 2. A virtual camera 20 represents the perspective of a user viewing the scene. A top portion 21 of camera 20 indicates the orientation of the scene. Object 2 may be moved by the user to any location on a drag plane 35, which is parallel to a floor 50. Though this description focuses on moving object 2 in a plane parallel to floor 50, drag plane 35 can be positioned anywhere the user desires to move object 2. A line of sight 30 is a line from camera 20 to object 2 that forms a first angle 5 with drag plane 35.

The user selects object 2 by pressing a mouse button while the cursor is on object 2. With the mouse button depressed, the user drags the cursor and object 2 towards a desired location. The user releases the mouse button at the final location. The movements of object 2 correspond to movements of the mouse. Therefore, from the perspective of camera 20, moving the mouse forward moves object 2 to the reader's right in FIG. 2, moving the mouse down moves object 2 to the reader's left, moving the mouse to the right moves object 2 out of the page towards the reader, and moving the mouse to the left moves object 2 into the page away from the reader.

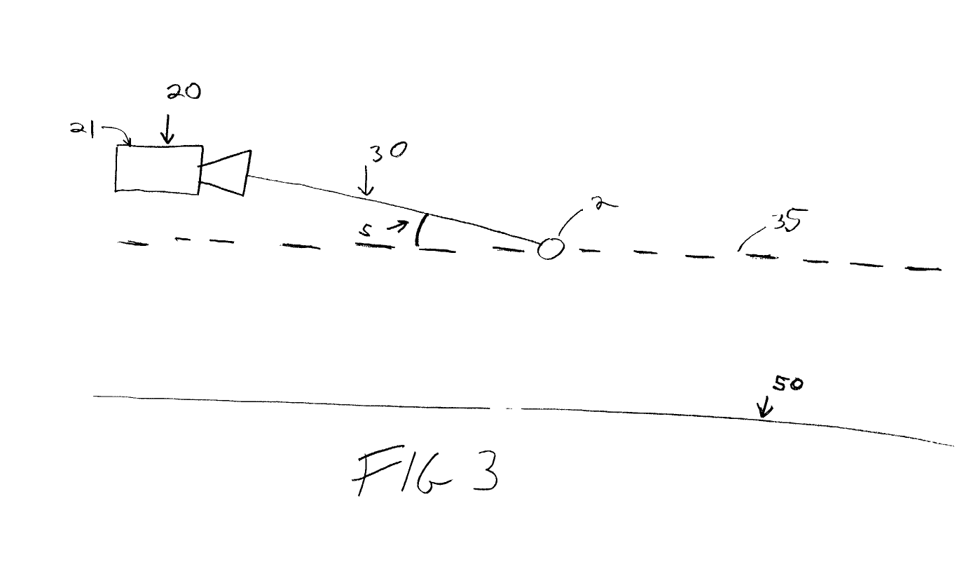

When first angle 5 is orthogonal, mouse-to-object movements are proportional from the user's perspective. That is, moving the mouse left, right, up or down has the same perceived change on a user's display. However, as first angle 5 decreases, mouse-to-object movements are no longer proportional. In FIG. 3, first angle 5 is reduced to an acute angle relative to drag plane 35. Therefore, moving object 2 using 2D techniques is not effective. For example, moving object 2 while object 2 is far from virtual camera 20 will result in large changes in Cartesian X-Y-Z distances for small changes in mouse movements. In other words, an object that is far into the distance in the 3D scene will move the same distance in 2D space as a closer object, but since the object is really further away in 3D space it moves a greater distance.

When first angle 5 is equal to zero degrees (camera 20 is on drag plane 35), moving a mouse forward or backward does not move object 2 at all because the cursor remains at the same position whereas left to right mouse movements move object 2. Stated another way, moving the mouse forward and backward to move the cursor into the screen and out of screen, respectively, does not change the position of the cursor in the 2D space. If camera 20 is below object 35, first angle 5 is negative. Moving the mouse forward moves object 2 backwards from the user's perspective and moving the mouse backwards moves object 2 forwards from the user's perspective.

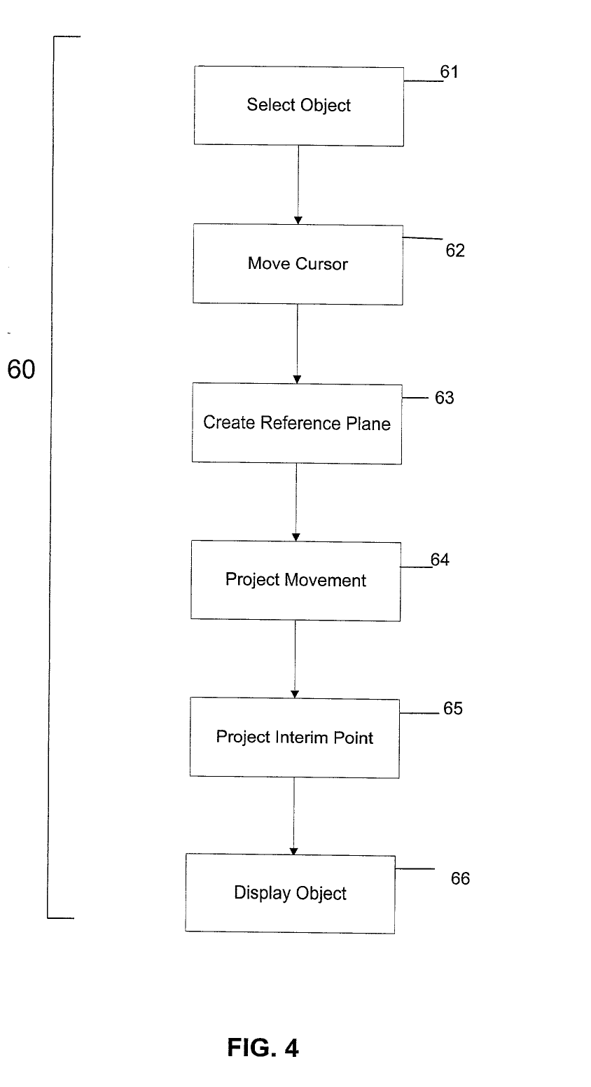

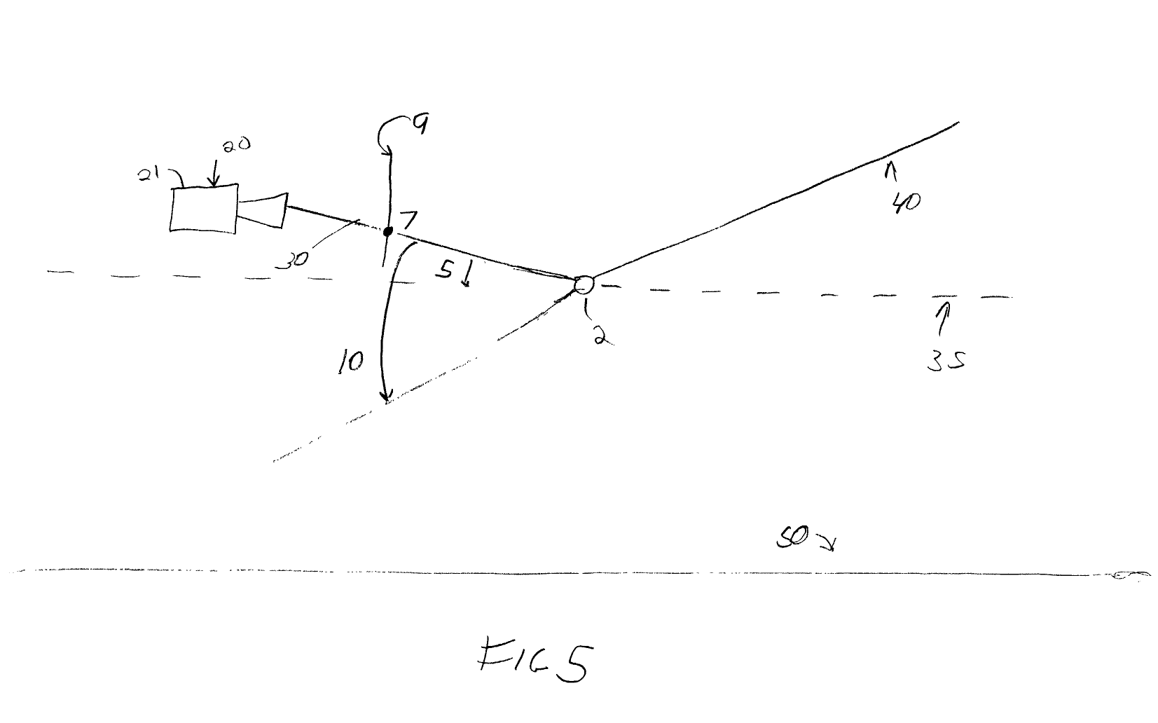

Referring to FIG. 4, a process 60 is shown for moving object 2 in a virtual 3D space using a 2D I/O interface. Briefly, process 60 starts with selecting object 2 and moving a cursor to a desired location. Referring to FIG. 5, process 60, moves object 2 to the desired location through the use of a reference plane 40 by projecting cursor movements onto reference plane 40 prior to projecting object 2 onto drag plane 35. In other words, object 2 is moved to the desired location by projecting the cursor onto reference plane 40 and then folding reference plane 40 onto drag plane 35 and projecting object 2 at a point where the cursor is on drag plane 35.

In more detail, process 60 selects (61) object 2. To do this, the user moves the cursor on top of object 2 and depresses a mouse button. In this embodiment, the cursor is hidden from the user's view after object 2 is selected for movement. Once movement begins, object 2 becomes a 3D cursor. In other words, without the regular cursor in view, movement of object 2 gives the user the visual cue to place object 2 where the user desires. If the cursor were visible, it would zigzag across the user's screen causing confusion because it would not have a logical relationship to the mouse movements.

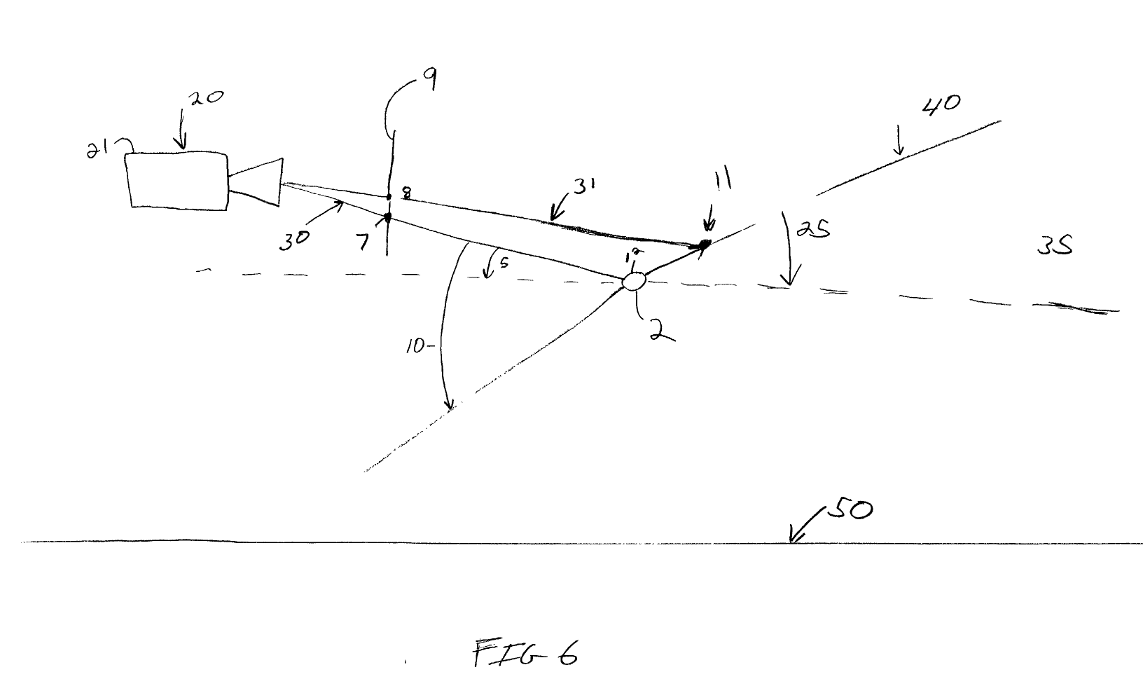

Process 60 moves (62) the cursor to the desired location. Movement of the cursor, though invisible to the user, is shown on display 9 (FIG. 6). The original position of the cursor is at a point 7. The new position is at a point 8.

Process 60 creates (63) reference plane 40 by determining a drag angle 10. Drag angle 10 is equal to the larger of first angle 5 and a predetermined minimum angle. In this embodiment, the predetermined minimum angle is 30 degrees; however, other angles may be used. Once drag angle 10 is determined, reference plane 40 is created such that it extends through object 2. Therefore, the creation of reference plane 40 is dependent on the position of camera 20, object 2, and drag angle 35.

Referring to FIG. 6, process 60 projects (64) movement of the cursor at point 8 by extending a line 31 from camera 20 through point 8 to an interim point 11. Point 11 is located at the intersection of reference plane 40 and line 31.

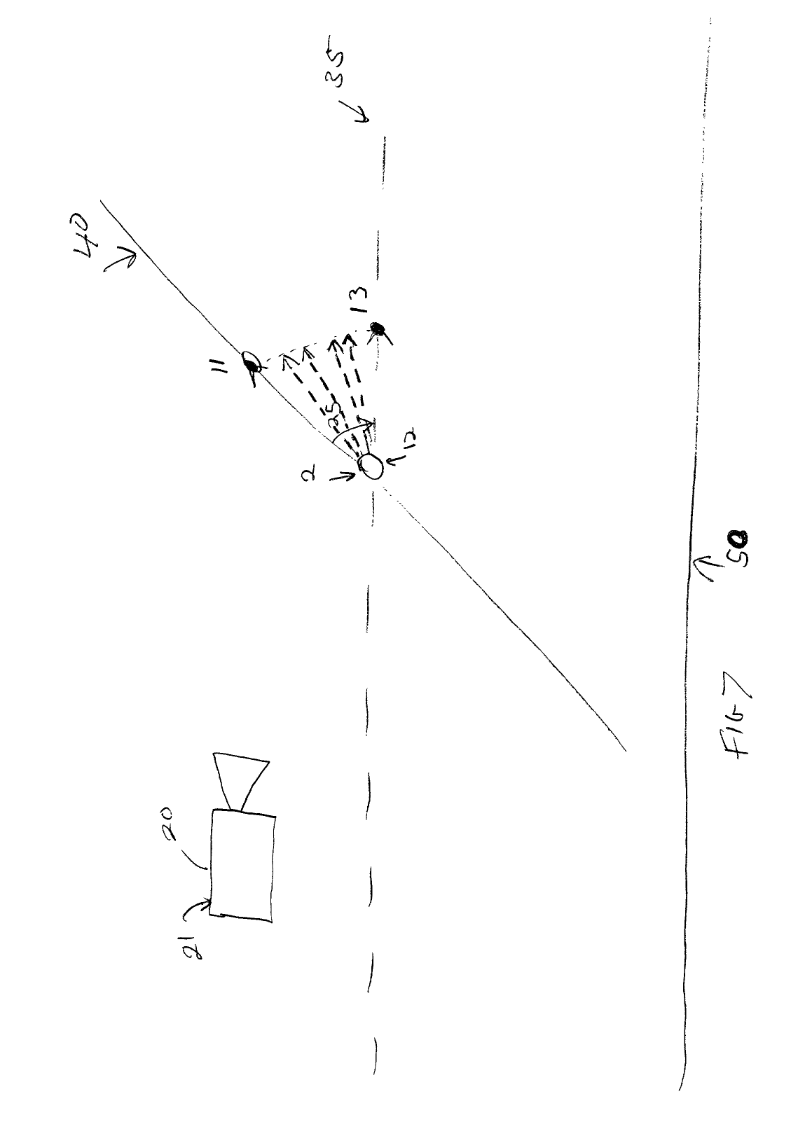

Referring to FIG. 7, process 60 projects (65) the cursor from interim point 11 onto drag plane 35. This may be accomplished in several ways. One way is to calculate the magnitude of a vector from an original object position 12 to interim point 11 and applying that magnitude along drag plane 35 in a direction that includes a plane that has original object position 12, interim point 11 and camera 20. In FIG. 7, the plane that includes all three points would be the plane of the paper. Therefore, the vector extends on the page to a projected cursor point 13.

A second way is to rotate the modified drag plane until a fold angle 25 is zero and projected cursor point 13 rests on drag plane 35. Fold angle 25 is the angle between reference plane 40 and drag plane 35. Process 60 displays (66) object 2 at the point 13 where the cursor is projected onto drag plane 35.

Before the user release the mouse button and as object 2 is moved from one location on display 9 to another location on display 9, process 60 may be reiterated numerous times before object 2 reaches its final location. A reference plane may be recalculated for changing camera 20, object 2, and drag plane 35 positions. After each translation, object 2 is projected onto drag plane 35. Therefore, to the user moving the 3D object across a screen, the movement seems like a fluid and uninterrupted process. When the user releases the mouse button, the cursor is displayed at the final location of object 2 and object 2 no longer functions as a 3d cursor.

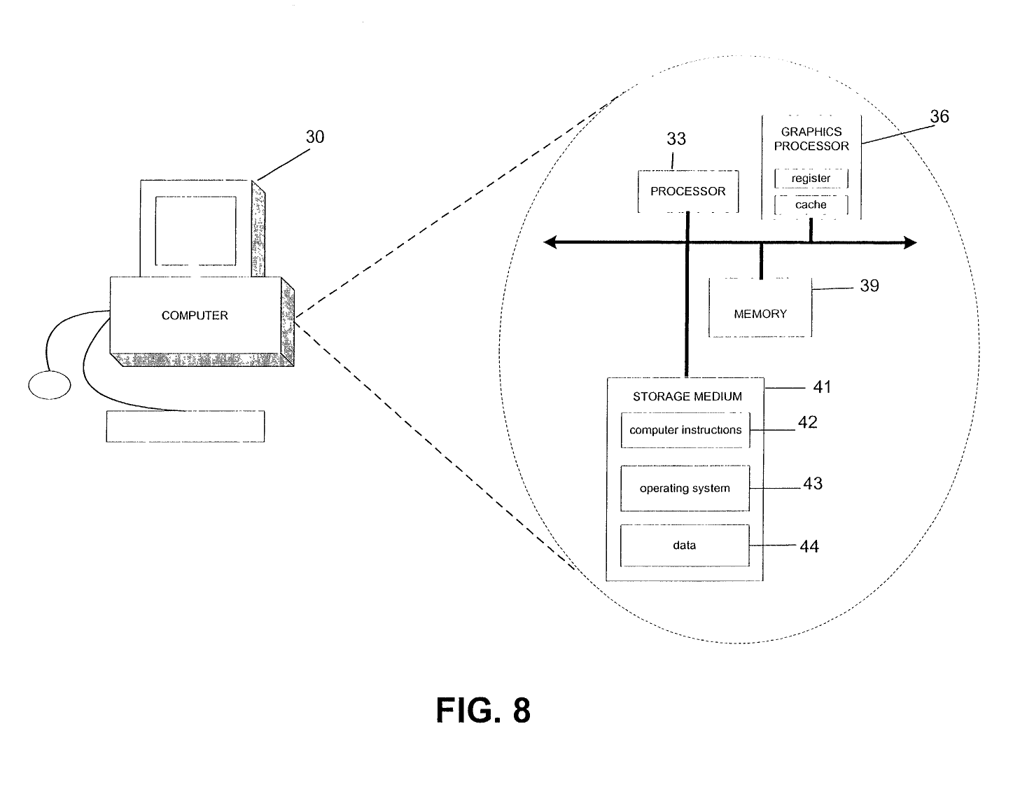

FIG. 8 shows a computer 30 for moving objects using process 60. Computer 30 includes a processor 33, a memory 39, a storage medium 41 (e.g., hard disk), and a 3D graphics processor 41 for processing data in the virtual 3D space of FIGS. 1 to 3 and 5 to 7. Storage medium 41 stores operating system 43, 3D data 44 which defines the 3D space, and computer instructions 42 which are executed by processor 33 out of memory 39 to perform process 60.

Process 60 is not limited to use with the hardware and software of FIG. 8; it may find applicability in any computing or processing environment and with any type of machine that is capable of running a computer program. Process 60 may be implemented in hardware, software, or a combination of the two. Process 60 may be implemented in computer programs executed on programmable computers/machines that each include a processor, a storage medium/article readable by the processor (including volatile and non-volatile memory and/or storage elements), at least one input device, and one or more output devices. Program code maybe applied to data entered using an input device to perform process 60 and to generate output information.

Each such program may be implemented in a high level procedural or objected-oriented programming language to communicate with a computer system. However, the programs can be implemented in assembly or machine language. The language may be a compiled or an interpreted language. Each computer program may be stored on a storage medium (article) or device (e.g., CD-ROM, hard disk, or magnetic diskette) that is readable by a general or special purpose programmable computer for configuring and operating the computer when the storage medium or device is read by the computer to perform process 60. Process 60 may also be implemented as a machine-readable storage medium, configured with a computer program, where upon execution, instructions in the computer program cause the computer to operate in accordance with process 60.

The invention is not limited to the specific embodiments described herein. For example, the invention can be used to move an object anywhere in a 3D space. Also, camera 20 may be moved to keep object 2 constantly in the user's view no matter where object 2 moves on the screen. Other I/O interfaces can be used instead of the mouse (e.g., a keyboard, trackball, input tablet, joystick). The invention is also not limited to use in 3D space, but rather can be used in N-dimensional space (N≧3). The invention is not limited to the specific processing order of FIG. 4. Rather, the blocks of FIG. 4 may be re-ordered, as necessary, to achieve the results set forth above.

Other embodiments not described herein are also within the scope of the following claims.

What is claimed is:

1. A method of moving an object on a drag plane in a virtual three-dimensional (3D) space, comprising:
selecting the object using a cursor;
moving the cursor to a location;
creating a reference plane;
projecting movement of the cursor from the location to an interim point on the reference plane;
projecting the interim point onto the drag plane; and
displaying the object on the drag plane.

2. The method of claim 1, wherein projecting the interim point comprises rotating the reference plane onto the drag plane.

3. The method of claim 1, further comprising:
calculating a first angle between a line of sight and the drag plane, wherein the line of site is a line from a virtual camera to the object; and
determining a drag angle by using a larger angle of the first angle and a predetermined minimum angle.

4. The method of claim 3, wherein the reference plane is created using the drag angle.

5. The method of claim 3, wherein the drag angle is measured from the line of sight to the reference plane.

6. The method of claim 3, wherein the predetermined minimum angle is 30 degrees.

7. The method of claim 1, further comprising:
hiding the cursor from a user's view;
wherein the object is displayed while the cursor is hidden.

8. The method of claim 7, further comprising:
deselecting the object; and
displaying the cursor following deselecting.

9. The method of claim 8, further comprising:
moving the cursor to the location of the object, wherein the cursor is displayed at the location of the object.

10. The method of claim 1, wherein a virtual camera moves to keep the object in a user's view.

11. An apparatus for moving an object on a drag plane in a virtual three-dimensional (3D) space, comprising:
a memory that stores executable instructions; and
a processor that executes the instructions to:
select the object using a cursor;
move the cursor to a location;
create a reference plane;
project movement of the cursor from the location to an interim point on the reference plane;
project the interim point onto the drag plane; and
display the object on the drag plane.

12. The apparatus of claim 11, wherein the processor executes instructions to rotate the reference plane onto the drag plane.

13. The apparatus of claim 12, wherein the processor executes instructions to:
calculate a first angle between a line of sight and the drag plane, wherein the line of site is a line from a virtual camera to the object; and
determine a drag angle by using a larger angle of the first angle and a predetermined minimum angle.

14. The apparatus of claim 13, wherein the reference plane is created using the drag angle.

15. The apparatus of claim 13, wherein the drag angle is measured from the line of sight to the modified drag plane.

16. The apparatus of claim 13, wherein the predetermined minimum angle is 30 degrees.

17. The apparatus of claim 11, wherein the processor executes instructions to:
hide the cursor from a user's view;
wherein the object is displayed while the cursor is hidden.

18. The apparatus of claim 17, wherein the processor executes instructions to:
deselect the object; and
display the cursor following deselecting.

19. The apparatus of claim 18, wherein the processor executes instructions to:
move the cursor to the location of the object, wherein the cursor is displayed at the location of the object.

20. The apparatus of claim 11, wherein a virtual camera moves to keep the object in a user's view.

21. An article comprising a machine-readable medium that stores executable instructions for moving an object on a drag plane in a virtual three-dimensional (3D) space, the instructions causing a machine to:
select the object using a cursor;
move the cursor to a location;
create a reference plane;
project movement of the cursor from the location to an interim point on the reference plane;
project the interim point onto the drag plane; and
display the object on the drag plane.

22. The article of claim 21, wherein projecting the interim point comprises rotating the reference plane onto the drag plane.

23. The article of claim 21, further comprising instructions that cause the machine to:
calculate a first angle between a line of sight and the drag plane, wherein the line of site is a line from a virtual camera to the object; and
determine a drag angle by using a larger angle of the first angle and a predetermined minimum angle.

24. The article of claim 23, wherein the reference plane is created using the drag angle.

25. The article of claim 23, wherein the drag angle is measured from the line of sight to the modified drag plane.

26. The article of claim 23, wherein the predetermined minimum angle is 30 degrees.

27. The article of claim 21, further comprising instructions that cause the machine to:
hide the cursor from a user's view;
wherein the object is displayed while the cursor is hidden.

28. The article of claim 27, further comprising instructions that cause the machine to:
deselect the object; and
display the cursor following deselecting.

29. The article of claim 28, further comprising instructions that cause the machine to move the cursor to the location of the object, wherein the cursor is displayed at the location of the object.

30. The article of claim 21, wherein a virtual camera moves to keep the object in a user's view.
